(19) United States
(12) Patent Application Publication
(10) Pub. No.: US 2004/0078337 A1
(43) Pub. Date: Apr. 22, 2004

(54) Electronic document management system and method

(76) Inventors: Shawn L. King, Kanata (CA); John Desrochers, Kanata (CA); Angus Stewart, Kinburn (CA); Douglas McNeil, Ottawa (CA)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/407,557

(22) Filed: Apr. 4, 2003

Related U.S. Application Data
(63) Continuation-in-part of application No. 09/923,615, filed on Aug. 6, 2001.

(51) Int. Cl. G06F 17/60

(52) U.S. Cl. 705/51

(57) ABSTRACT

This invention relates generally to the field of electronic commerce software applications and, more particularly, to an electronic system and method for creating, managing and authenticating documents, such as commercial contracts, in electronic form. A system is provided to accommodate the automatic input of externally generated content. A system generated cover page containing user selected data is provided which is attached to externally generated content (e.g. a custom agreement) and which is used to track a document image inputted into the system. The cover page contains unique system generated barcode information which allows the cover page and associated custom agreement to be tracked, retrieved and validated by authorized users of the system. The barcode reflects the document number, revision number and a unique system generated document digest. The system also contemplates the use of redundant barcodes and a digest reference, both of which serve to uniquely identify the document, while minimizing scan error rates.

### CROSS-REFERENCE TO RELATED APPLICATIONS

This is a continuation-in-part of application Ser. No. 09/923,615, filed Aug. 6, 2001 and entitled “Electronic Document Management System and Method”

### FIELD OF THE INVENTION

This invention relates generally to the field of electronic commerce (“e-commerce”) software applications and, more particularly, to an electronic system and method for creating, managing and authenticating documents, such as commercial contracts, in electronic form.

### BACKGROUND OF THE INVENTION

Cryptography is frequently employed within networked systems as a security measure and uses private and public keys. The terms “private key” and “public key” are well known terms of art and are used for asymmetric cryptography in which one key is used for encryption and the other for decryption and one of these keys, namely the private key, is kept by the user and never revealed or transferred. Asymmetric cryptography is considered to provide a higher level of security than symmetric cryptography for which a shared key is used for both encryption and decryption (the sharing aspect introducing an element of insecurity). When using asymmetric cryptography to send a message to another party, the public key of that party is located by means of a public key infrastructure (PKI) and is used to encrypt the message; then, only the person with the corresponding private key (i.e. being the other party for whom the message is created) is able to decrypt the message.

The term digital signature is also a well known term of art and refers to a message digest encrypted using a private key, a message digest being a condensed form of a document or transaction to be signed which cannot be used to recreate the document or transaction itself, and which is extremely sensitive to small changes in the document. The digital signature is verified by decrypting it with the corresponding public key to recover the message digest and then comparing the recovered message digest with one computed by a verifier using the document which was purported to be signed. Although encrypted message digests may be used to verify that a party holds a specific private key they are more commonly used to prove that the holder of a specific key was involved in a transaction involving the message; for example, to identify that they gave their assent to the message, just as a physical signature is used to indicate the participation of the signing party in a document. In this case, the encrypted form of the digest must be retained at a secure site.

One of the problematic aspects of e-commerce is the necessity to verify both the parties and the contents of any given transaction (e.g. contract). The foregoing electronic security technologies are available to authenticate the parties participating in a transaction (i.e. electronic signatures, digital certificates and third party authentication) but these technologies are insufficient to also enable a user to validate the exact content of a document signed by the parties thereto. This is a substantial concern associated with e-commerce given the ease with which the data that makes up an electronic contract can become corrupt and thereby make the enforcement of these kinds of contracts very difficult.

There is a need, therefore, for a more effective and flexible means for validating the verity of an electronically generated and authenticated document such as a commercial contract, whereby both the contents and signatures may be matched to one another. Further is a need for a means to readily identify and track the changes made to such an electronic document during its lifecycle.

### SUMMARY OF THE INVENTION

The invention provides an electronic system and method for creating, managing and authenticating documents (e.g. commercial contracts) whereby the content, revision status and authenticating parties are stored, tracked, retrieved and validated on demand by permitted users. More specifically, a system is provided to accommodate the automatic input of externally generated content. A system generated cover page containing user selected data is provided which is attached to externally generated content (e.g. a custom agreement) and which is used to track a document image inputted into the system. The cover page contains unique system generated barcode information which allows the cover page and associated custom agreement to be tracked, retrieved and validated by authorized users of the system. The barcode reflects the document number, revision number and a unique system generated document digest. The system also contemplates the use of redundant barcodes and a digest reference, both of which serve to uniquely identify the document, while minimizing scan error rates.

In accordance with a first aspect of the invention there is provided an electronic document management system for verifying externally generated content exchanged through a network, the externally generated content associated with a user generated cover page, the system comprising: a data capturing component for capturing data defining the cover page, wherein the data comprises at least user selected data, and forwarding the data for storage; a document digest generator for generating a digest from the defined cover page and the associated externally generated content by applying a secure algorithm thereto, whereby the digest is uniquely associated with the defined cover page and the associated externally generated content, and forwarding the digest for storage in association with the defined cover page and the associated externally generated content; a barcode generator for generating a barcode from the generated digest wherein the barcode uniquely identifies the defined covered page and the associated externally generated content; a document forwarding component for forwarding the defined cover page with the barcode added thereto and the associated externally generated content to a recipient; a document receiving component for receiving from the recipient the associated externally generated content preceded by the defined cover page; and, a barcode verification component for determining the validity of said barcode of the received cover page wherein a digest component of the barcode is compared to the stored digest associated with the defined cover page document and the externally generated content.

In accordance with a second aspect of the invention, there is provided a method for managing and verifying externally generated content exchanged through a network, the externally generated content associated with a user generated cover page, the method comprising: capturing data defining the cover page, whereby the data comprises at least user selected data, and forwarding the data for storage; generating a digest from the defined cover page and associated externally generated content by applying a secure algorithm thereto whereby the digest is uniquely associated with the defined cover page and the associated externally generated content, and forwarding the digest for storage in association with the defined cover page and the associated externally generated content; generating a barcode from the generated digest wherein the barcode uniquely identifies the defined cover page and the associated externally generated content; forwarding the defined cover page with the barcode added thereto and the associated externally generated content to a recipient; receiving from the recipient the associated externally generated content preceded by the defined cover page; and, determining the validity of the barcode of the received cover page wherein a digest component of the barcode is compared to the stored digest associated with the defined cover page and the associated externally generated content.

In accordance with a third aspect of the invention, there is provided an electronic document management system for verifying the contents of an electronic document exchanged through a network and comprising variable data input by a user, the system comprising: a data capturing component for capturing data defining an electronic document, wherein the data comprises at least the variable data, and forwarding the data for storage; a document digest generator for generating a digest from the defined electronic document by applying a secure algorithm thereto, wherein the digest is uniquely associated with the defined electronic document, and forwarding the digest for storage in association with the defined electronic document; an identifier generator for generating at least two matching indicators and a digest reference wherein the at least two matching indicators and the digest reference uniquely identify the defined electronic document and the contents thereof; a document forwarding component for forwarding the defined electronic document with the at least two matching indicators and the digest reference added thereto for use by a user, a document receiving component for receiving from a user a signed electronic document comprising variable data, at least two matching indicators and a digest reference; and, an indicator and digest verification component for determining the validity of the at least two indicators and the digest reference associated with the received electronic document.

In accordance with a fourth aspect of the invention, there is provided an electronic document management system for verifying externally generated content exchanged through a network, the externally generated content associated with a user generated cover page, the system comprising: a data capturing component for capturing data defining the cover page, wherein the data comprises at least user selected data, and forwarding the data for storage; a document digest generator for generating a digest from the defined cover page and the associated externally generated content by applying a secure algorithm thereto, whereby the digest is uniquely associated with the defined cover page and the associated externally generated content, and forwarding the digest for storage in association with the defined cover page and the associated externally generated content; a barcode generator for generating at least two matching barcodes and a digest reference wherein the at least two matching barcodes and the digest reference uniquely identify the defined covered page and the associated externally generated content; a document forwarding component for forwarding the defined cover page with the at least two matching barcodes and the digest reference added thereto, and the associated externally generated content to a recipient; a document receiving component for receiving from the recipient the associated externally generated content preceded by the defined cover page; and, an barcode and digest verification component for determining the validity of the at least two barcodes and the digest reference associated with the received cover page.

In accordance with a fourth aspect of the invention, there is provided an electronic document management system for verifying the contents of an electronic document exchanged through a network and comprising variable data input by a user, the system comprising: a data capturing component for capturing data defining an electronic document, wherein the data comprises at least the variable data, and forwarding the data for storage; a document digest generator for generating a digest from the defined electronic document by applying a secure algorithm thereto, whereby the digest is uniquely associated with the defined electronic document, and forwarding the digest for storage in association with the defined electronic document; a barcode generator for generating a barcode from the generated digest whereby the barcode uniquely identifies the defined electronic document and the contents thereof; a document forwarding component for forwarding the defined electronic document with the barcode added thereto for use by a user; a document receiving component for receiving from a user a signed electronic document comprising variable data and a barcode; and, a barcode verification component for determining the validity of the barcode of the received electronic document wherein a digest component of the barcode is compared to the stored digest associated with the defined electronic document, wherein the defined electronic document is a template contract the barcode generator calculates the space available on a specified page of said template contract adjusts the size and placement of said barcode accordingly. For processing digitally-signed documents a unique digital exchange key is generated by applying the secure algorithm to an electronic image of the defined cover page which is then stored in association with the defined cover page.

In use, the barcoded cover page is authenticated by the parties either by hand-signing a printed copy of the barcoded document or by applying a digital signature using a third party validation service. The resultant barcoded, signed and authenticated document is associated to the variable data originally input by the user by cross-referencing the digest component of that barcode to the stored digest associated with the defined electronic document. Upon successful association the system binds the signed document (an electronic image) to the original input data. The electronic storage of the resulting bound documents permits authorized users to locate existing documents (e.g. contracts), track document revisions and validate document contents and signatories.

### DESCRIPTION OF THE DRAWINGS

The present invention is described in detail below with reference to the following drawings in which like reference numerals refer throughout to like elements.

FIG. 1 is an operational block diagram showing the hardware components of, and steps performed by, a preferred implementation of an electronic document management system in accordance with the invention;

FIG. 2 is a sample barcoded contract established by the electronic document management system of FIG. 1;

FIG. 3 is an alternate sample barcoded contract established by the electronic document management system of FIG. 1;

FIG. 4A is a flow chart showing the steps of a method for creating and storing a barcoded document in accordance with the invention;

FIG. 4B is a flow chart showing the steps of a method for receiving and storing a hand-signed barcoded document in accordance with the invention;

FIGS. 5A and 5B are a flow chart showing the steps of a method for receiving and storing a digitally signed barcoded document in accordance with the invention (the flow chart of FIG. 5B continuing from that of FIG. 5A);

FIGS. 6A and 6B depict start pages where the page count is known and which are used in association with an alternate embodiment of the invention;

FIGS. 6C, 6D, 6E and 6F depict start and end pages where the page count is unknown and which are used in association with an alternate embodiment of the invention;

FIG. 7 depicts a typical user interface used in association with an alternate embodiment of the invention;

FIG. 8 is a flow chart showing the steps of a method for creating and storing a cover page in accordance with an alternate embodiment of the invention; and

FIG. 9 is a flow chart showing the steps of a method for receiving and storing a hand-signed custom agreement with an associated cover page in accordance with an alternate embodiment of the invention.

### DETAILED DESCRIPTION OF A PREFERRED EMBODIMENT

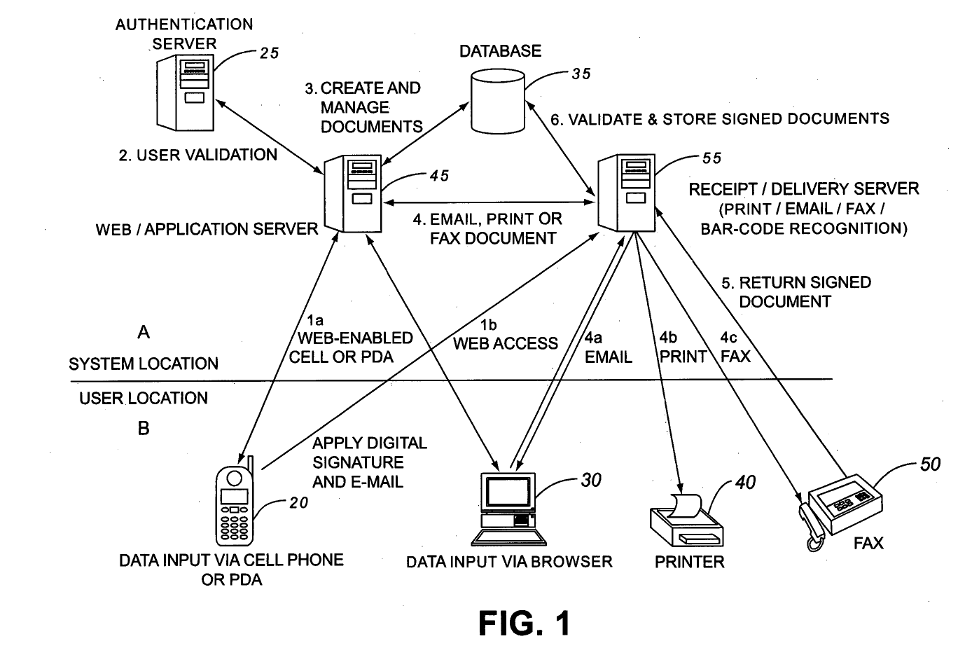

The present invention is an electronic document management system which, in the preferred embodiment described herein, is implemented in software components. FIG. 1 shows hardware components which are used to implement a preferred embodiment of the electronic document management system. The components of the illustrated system are shown in the top portion “A” of FIG. 1 and the alternative and/or complementary user components, comprising a web-enabled cell phone/personal digital assistant (PDA) 20, PC 30, printer 40 and/or fax machine 50, are shown in the bottom portion “B” of FIG. 1.

The electronic document management system operates on hardware which includes a secure Authentication server 25 for communicating in a secure manner with a Web/Application server 45 to validate users of the system. A Web/Application server 45 interfaces to the user's web-enabled cell phone and PC components 20, 30 for data transfer therebetween and also communicates with a secure Database 35 to create and manage electronic documents. A Receipt/Delivery server 55 receives documents from the Web/Application server 45 and interfaces to the user components PC 30, printer 40 and fax 50 to email, print or fax documents, respectively. The Receipt/Delivery server 55 also receives authenticated (i.e. signed) faxed documents from the user via the fax machine 50. The Receipt/Delivery server 55 communicates with the Database 35 to validate and store signed documents. The functionality and components of the Authentication, Web/Application, Database and Receipt/Delivery servers 25,45,35, 55 of this preferred embodiment are detailed below. However, it is to be understood by the reader that the software components of the electronic document management system may be implemented by means of different software/hardware configurations and components for alternative embodiments.

The Web/Application server 45 provides two functions, namely, a Web server function and an Application server function. The Web server function runs applications for displaying system screens and documents to the user in a user-requested format (HTML, WML, PDF, etc.). The Application server function runs components of the electronic document management system including a document forwarding component which forwards documents for faxing, emailing and printing by the Receipt/Delivery server 55. It also receives input from the Web server, validates user inputs and stores those inputs in the Database 35. Hardware and software components used for the Web/Application server 45 in the preferred embodiment are the following:

System: Redhat Linux 7 [other options: Windows NT, or Solaris 7]

Processor: Pentium III 1000 MHz [other options: UItraSPARC]

Memory: 512 MB (or more)

Disk: redundant 9 GB (or more)

Application Software:

Web Server: Apache 1.3 with SSL supporting high security connections.

JSP/Servlet Server: Tomcat 3

Development Software:

Java 1.3

Java Database Connectivity (JDBC) 2.0

Java Server Pages (JSP) 1.1

Java Servlets 2.2

Apache Batik 1.0, FOP 0.19, Xalan 2.0.0, Xerces 1.2.3

The Database (with an associated server) 35 provides storage for storing user inputs and document identification data including digests and signed electronic documents (i.e. images). The hardware and software components used for the Database (and server) 35 in the preferred embodiment are the following:

System: Redhat Linux 7 [other options: Windows NT, or Solaris 7]

Processor: Pentium III 1000 MHz [other options: UltraSPARC]

Memory: 1024 MB (or more)

Disk: array of suitable size for storage needs

Database: Oracle 8i RDBMS [other options: DB2, or SQL Server]

The Authentication server 25 performs user account maintenance functions. These functions include user and password authentication, account expiry, maintenance of user attributes, account locking and account disabling. The hardware and software components used for the Authentication server 25 in the preferred embodiment are the following:

System: Redhat Linux 7 [other options: Windows NT, or Solaris 7]

Processor: Pentium III 1000 MHz (or more) [other options: UltraSPARC]

Memory: 512 MB (or more)

LDAP application software Planet [other options: Open LDAP or Oracle]

The Receipt/Delivery server 55 receives documents from the Application server 45 and emails, prints or faxes them to a specified destination. The Receipt/Delivery server 55 also receives faxed or e-mailed signed documents by means of a document receiving component and interacts with the Database 35 for storage. The hardware and software components used for the Receipt/Delivery server 55 in the preferred embodiment are the following:

System: Redhat Linux 7 [other options: Windows NT, or Solaris 7]

Processor: Pentium III 1000 MHz [other options: UltraSPARC]

Memory: 512 MB (or more)

Fax Application software: Efax [or Hylafax]

Print Application software: LPRng

Email Application software: Sendmail 8, Imapd, and JavaMail 1.2

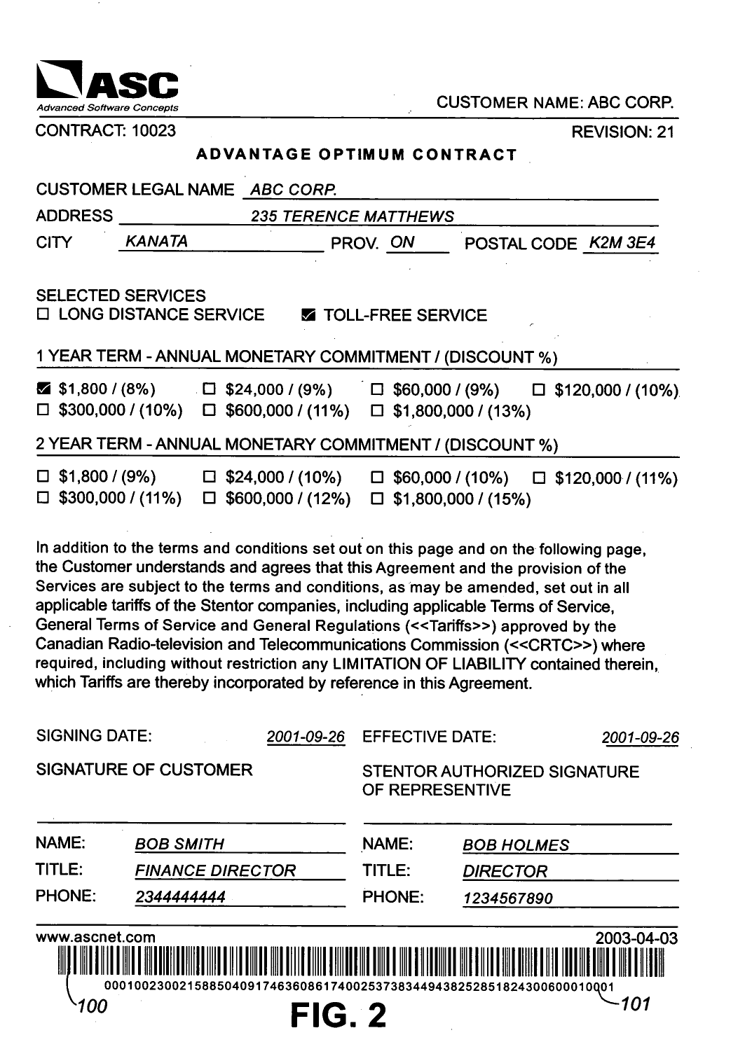

FIG. 2 represents a sample document, being a commercial contract in this illustration, created from a template generated by the subject electronic document management system.

Variable data is input by the user (via cell phone/PDA 20 or PC 30), and captured by a data capturing component of the system using a predetermined electronic template such that the variable data, in the context of that particular template, defines an electronic document. A form-type document template is contemplated for use by the preferred embodiment described herein but any type of template may be used, as desired, for a particular application and does not restrict, or form part of, the electronic document management system claimed herein.

A representation of the variable input data, system-assigned document and revision numbers and fixed document template data is copied by the Application server 45 into an array of bytes to which NIST's secure hash algorithm is applied by a document digest generator component to generate a unique document digest. A Java security object (employing the Java software products of Sun Microsystems, Inc. of California, U.S.A.) is used to implement NIST's secure hash algorithm known as SHA. This algorithm is well known by persons skilled in the art and it is broadly published and available to the public, for example, see FIPS PUB 180-1, Federal Information Processing Standards Publication, Secure Hash Standards, issued Apr. 17, 1995 by the U.S. Department of Commerce. The document number, revision number and paging details for that document are combined with the generated unique digest to produce a document identifier which is uniquely associated with a specific page of that specific document. This unique document identifier is then converted to a 2 OF 5 Interleaved formatted barcode 100 (see FIG. 2) using a barcode generator component and inserted into the associated page of the document (see the barcode 100 applied to the document of FIG. 2). A numeric string 101 reflects the digest captured in the barcode. As can be seen in FIG. 2, the paging details are listed as an 8 digit integer affixed to the trailing end of numeric string 101, with the first four digits representing the current page and the last four digits representing the total number of pages (i.e. 00010001 indicates the first page of a one page document). The actual size (scale) of the barcode 100 and numeric string 101 are determined by the system, based on a analysis of a specified page in the document. The goal is to provide the largest possible indicators (barcode 100 and numeric string 101) to facilitate scanning when the document is faxed Receipt/Delivery server 55.

Advantageously, the generated barcode is unique to the specific contents of the associated document page and, as such, any change made to the contents of that page may be identified and tracked by reference to this barcode and any subsequent barcodes derived for revisions of the document.

A signature is applied to the document using one of the following alternative methods:

1. The document may be printed by a user via printer 40, hand-signed by all parties, and then faxed via fax machine 50 to the Receipt/Delivery server 55 (in this case it is assumed that the hand-signing of the document is locally validated e.g. the party faxing back the signed document may be a representative of the contracting authority, such as a sales person, and may be assumed to have validated, by witnessing, the signing of the document of the other party who may be a customer); or,

2. Digital signatures may be applied to the document using third party validation services and then forwarded to the Receipt/Delivery server 55 via cell phone/PDA 20 or PC 30.

The Receipt/Delivery server 55 receives a signed document and for each page uses a barcode verification component to identify and validate the barcode therein, comparing the digest of the received document with that of the document data associated with the defined (i.e. original) document. Once the document has been validated the Receipt/Delivery server 55 stores it within Database 35.

To validate that the contents of a received document are identical to the original document, the barcode is parsed to determine the document number, revision number, paging details and digest. The document number is used to retrieve the defined document from the Database 35. The digest for the defined document is compared to the digest of the barcode of the received document. Any difference between the new digest value and the stored digest value for the defined document results in a determination that the received document is invalid. The received document is then placed in a rejection queue for manual intervention.

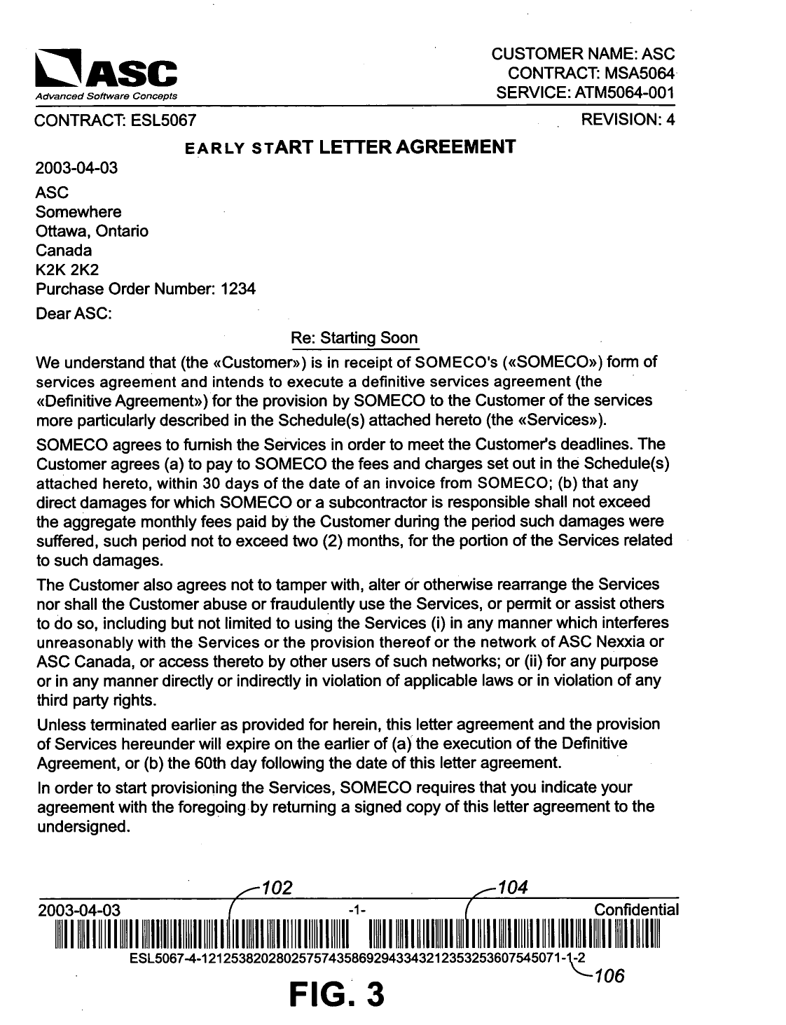

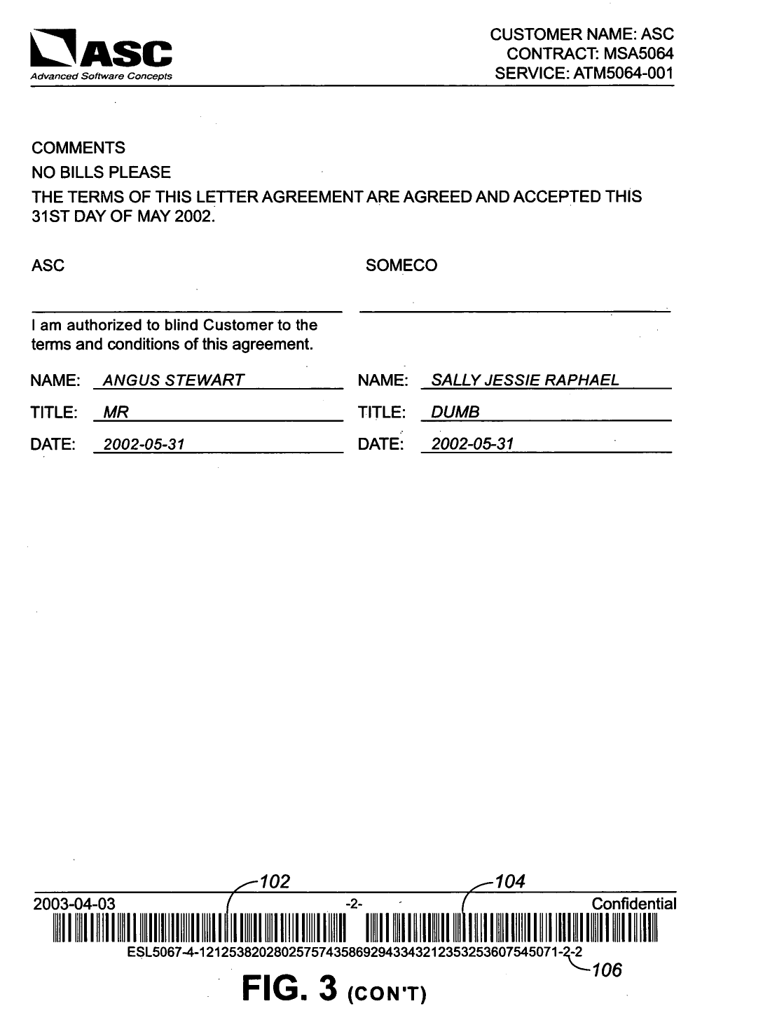

FIG. 3 represents an alternate embodiment of the commercial contract of FIG. 2. As can be seen at the bottom of the figure, the commercial contract includes two barcodes 102, 104 as well as a numeric string 106. This form of contract provides an additional level of verification and/or serves to reduce rejection errors. The alpha-numeric string 106 is a digest reference, which encapsulates the document number, revision number and paging details reflected in the unique document digest discussed in relation to FIG. 2. Barcodes 102 and 104 are identical and contain document number, revision number and page number coding. Due to faxing and other problems arising in data transmission, an individual barcode may become corrupted. As a result, when the barcode is scanned after the associated document is signed and inputted into the system (as discussed above), the contract may be rejected due an illegible barcode. Barcodes are scaled according to a calculation based on the length of the content the barcode contains. Redundant barcodes and optimum scaling of barcodes enable the system to scan all of the codes present on a selected page, and if at least one of them is legible, the page will be accepted. Alternately, to ensure that only valid pages are accepted by the system, the multiple barcodes present on a page can be scanned and if at least two of the barcodes match, the page will be accepted. As will be appreciated by those skilled in the art, the number and scale of redundant barcodes attached to a given page is limited only by the space availability on the page. Additionally, the number of barcodes which must be matched before the page is accepted can also be varied depending on the level of security desired by the user. It should also be understood that although the preferred embodiment is described in relation to barcodes any suitable indicator could be used such as a combination of a barcode and text, a three-dimensional image or the like. Such alternate indicators are meant to be included within the scope of the invention.

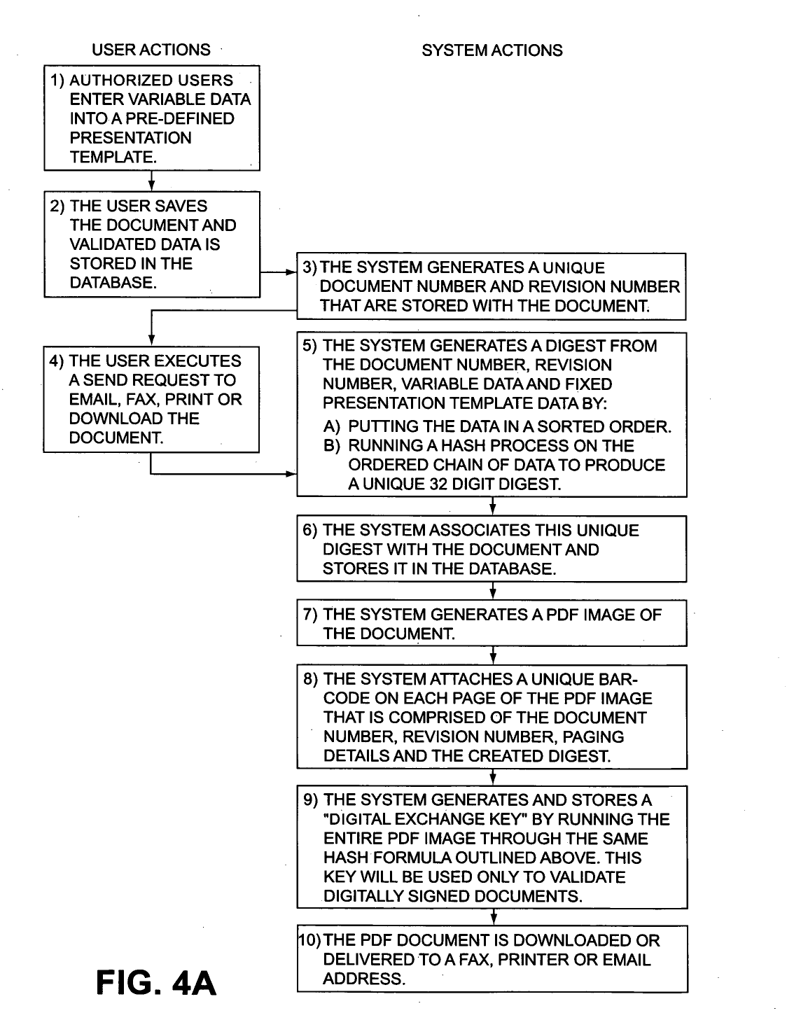

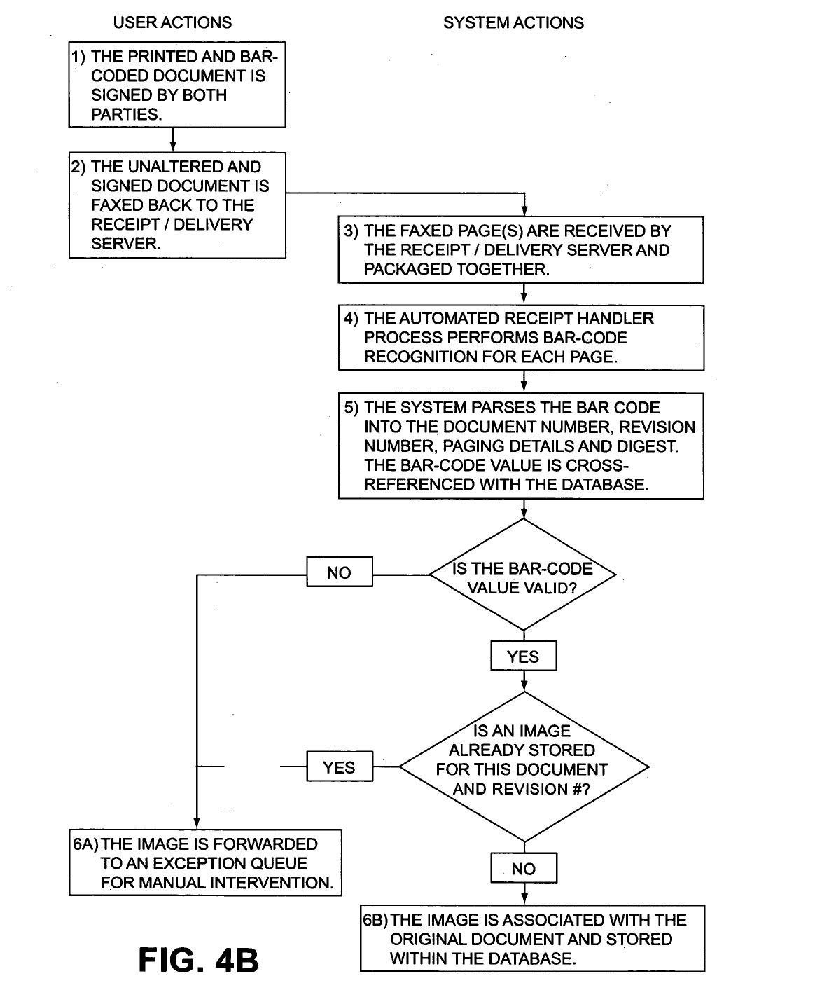

The flowchart of FIG. 4A shows a preferred sequence of steps performed by the system to create and store a barcoded electronic document in accordance with the invention. An authorized user enters variable data into a predetermined electronic form template. The user-input variable data is validated and the document is stored in the Database 35 together with a system-generated unique document number and revision number for that document. A document digest is generated as described above and the resulting digest is associated with the document and stored in the Database 35. A document image generator component of the system then generates an image of the document, this being an Adobe® portable document format (PDF) image in the illustrated example. A unique barcode 100, comprising the document and revision numbers, document digest and paging details, is generated and attached to each page of the document image (see FIG. 2). In the case of the contract of FIG. 3, matching barcodes 102, 104 are placed on each page representing the document and revision numbers and paging details, while a digest reference comprised of a unique alpha-numeric string 106 is also attached to each page. For use in validating digitally signed documents, a digital exchange key generator component generates a digital exchange key by applying the same hash algorithm to the entire document image (i.e. the entire PDF file in this example) and this digital exchange key is stored in Database 35. The document image is then forwarded for delivery to a user's fax, printer or email address.

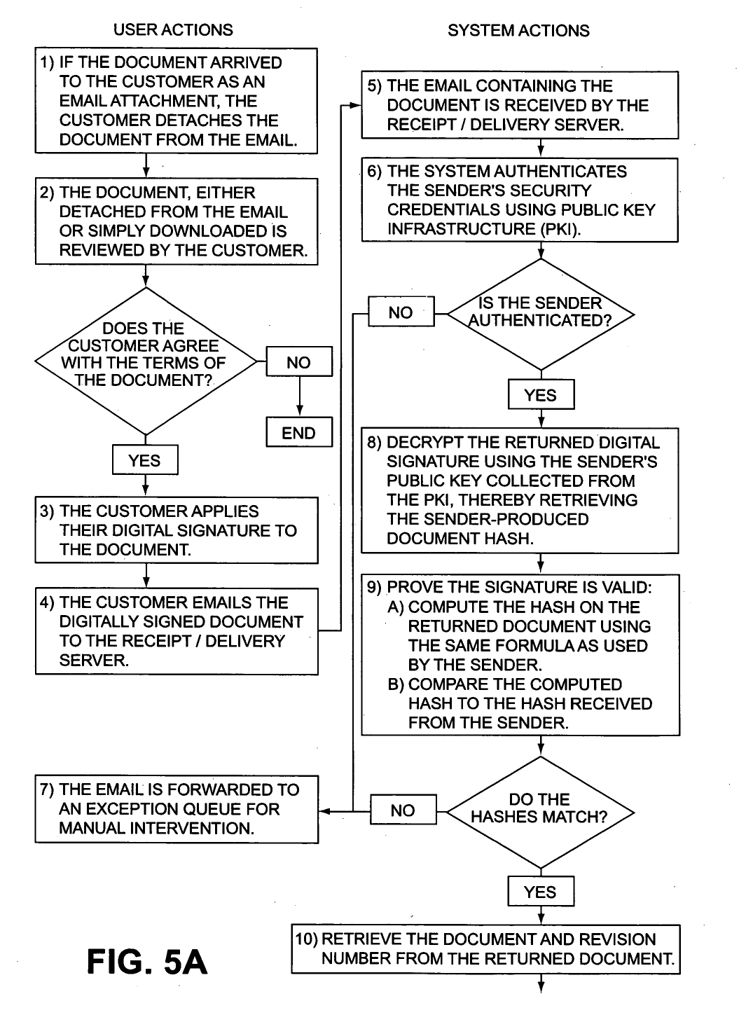

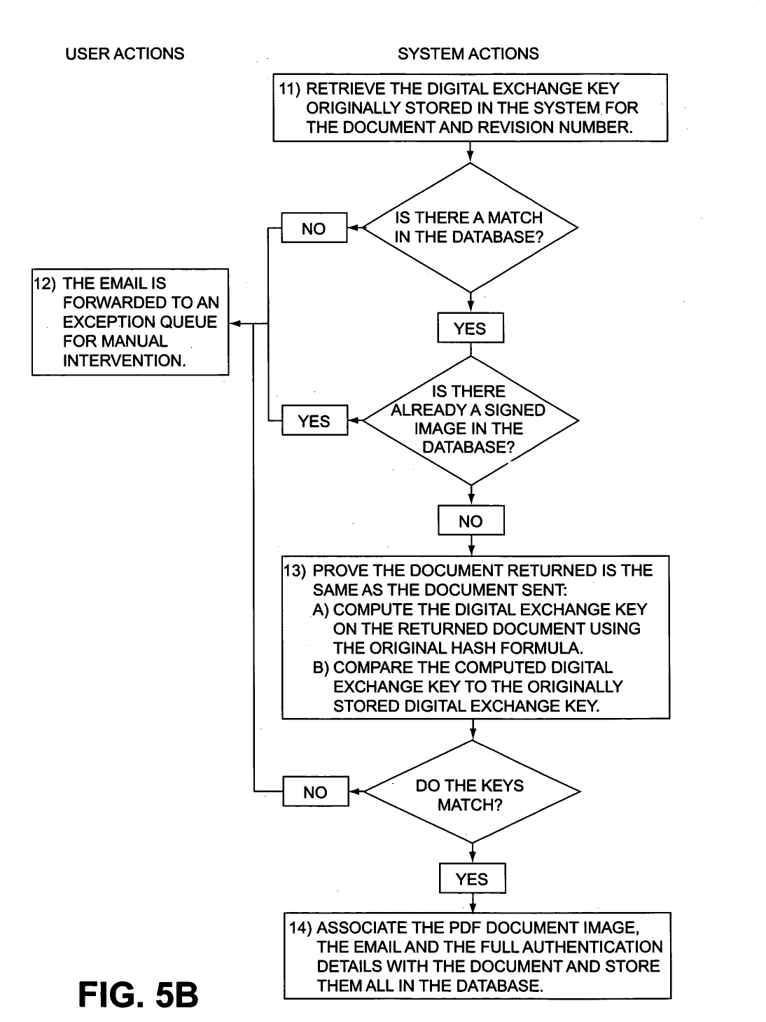

The flowcharts of FIGS. 4B and 5A, 5B show preferred sequences of steps performed by the system to receive, verify and store hand-signed and digitally-signed barcoded documents, respectively. As detailed by FIG. 4B, for a hand-signed document it is faxed to the Receipt/Delivery server 55 and that server scans the barcode from each page of the electronic copy of the faxed-in document. If the one or more barcodes cannot be located on the pages or at least one conforming barcode on a selected page of the document cannot be found (apart from the page number) then the electronic copy of the faxed-in document is forwarded to a local exception queue for manual intervention. In the case of a FIG. 3 contract, if the two barcodes 102, 104 do not match, then the faxed-in document will also be forwarded to the exception queue. The scanned barcodes are parsed into their components: document number, revision number, paging details, and digest; and these components are cross-referenced to those stored in the Database server 35 for the defined document. In the case of a FIG. 3 contract, the digest reference comprised of alpha-numeric string 106 is cross-referenced to the stored digest. In either case, if the values do not match any stored value, or if there is already an image of a signed document stored for the document values, the electronic copy of the faxed-in document is forwarded to an exception queue for manual intervention. If an image has not yet been stored, the image of the signed document is associated with the original stored document and stored in the Database 35.

As detailed by FIGS. 5A and 5B, for a digitally-signed document the user applies their digital signature to the document if they agree to the terms of the document and the digitally signed document is then e-mailed to the Receipt/Delivery server 55 where the user's security credentials are authenticated by a digital signature authentication component using the Public Key infrastructure (PKI). If the user is authenticated the digital signature authentication component decrypts the digital signature using the user's public key collected from the PKI and thereby retrieves the document hash as computed by the user. The digital signature authentication component then verifies the validity of the signature by applying to the received document the same hash formula used by the user and the resulting hash value is compared to the hash value retrieved from the digital signature received from the user (it is to be noted that this hash formula is applied for purposes of the selected cryptographic processes for applying the digital signature and it is not the same hash formula applied by the system to produce the document digest). If the hash values do not match, the verification process has failed and the email is forwarded to another mailbox for manual intervention. If they do match, the document and revision numbers are retrieved from the received document and, using this information, a digital exchange key verification component retrieves from the Database 35 the stored digital exchange key which is associated with those document and revision numbers. If an associated digital exchange key cannot be located, or if an existing signed image is already stored, then the verification process has failed and the email is forwarded to another mailbox for manual intervention. If an associated digital exchange key is located and no existing signed image exists, the digital exchange key verification component takes steps to prove the returned document is the same as the sent document. To do so, it computes the digital exchange key for the received document using the original hash formula and the computed digital exchange key is compared to the stored digital exchange key for the defined (i.e. original) document. If the keys do not match the verification process has failed and the email is forwarded to another mailbox for manual intervention. If the keys match the document image, the email and the full authentication details are associated with the defined document and all of these are stored in the Database 35.

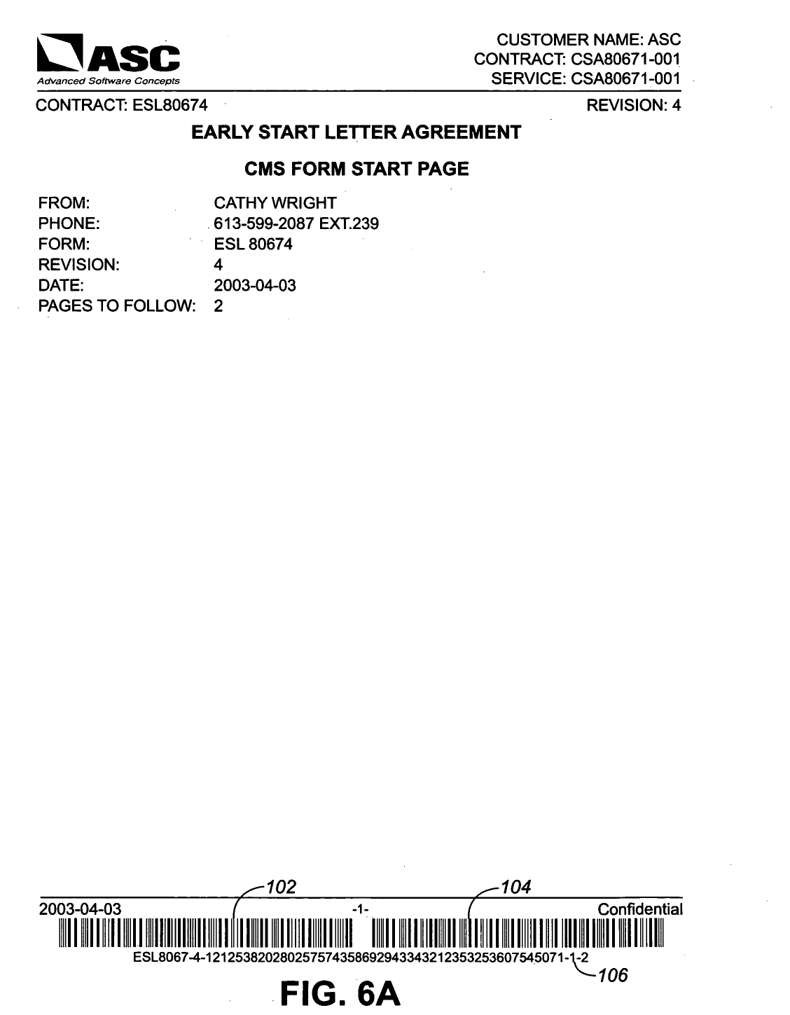

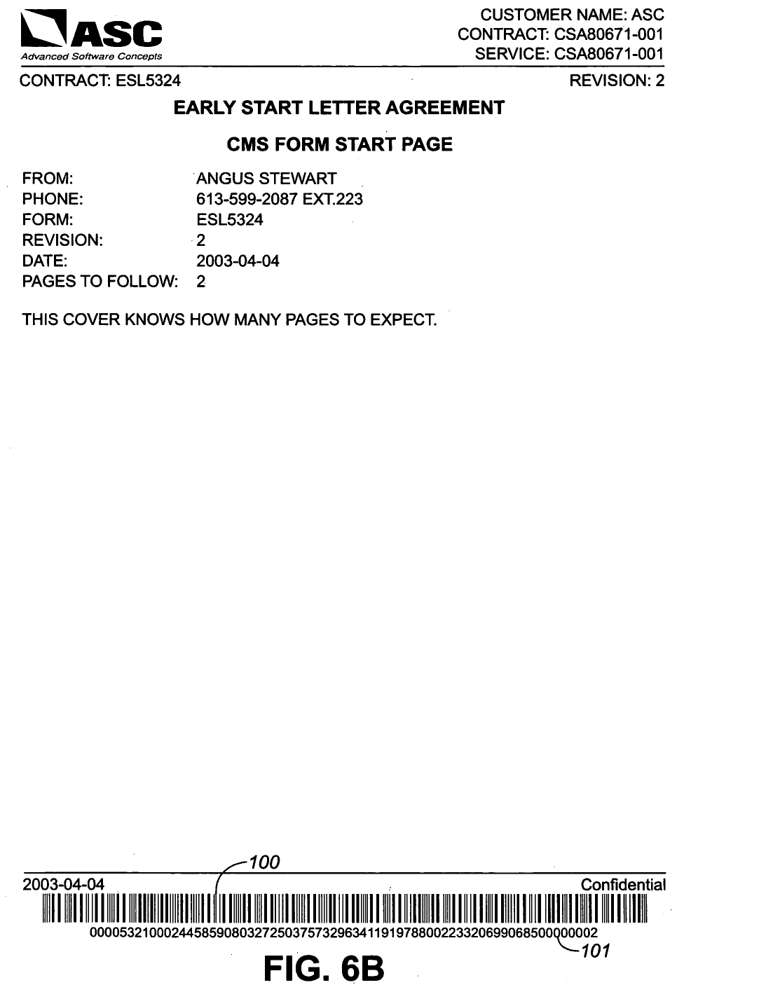

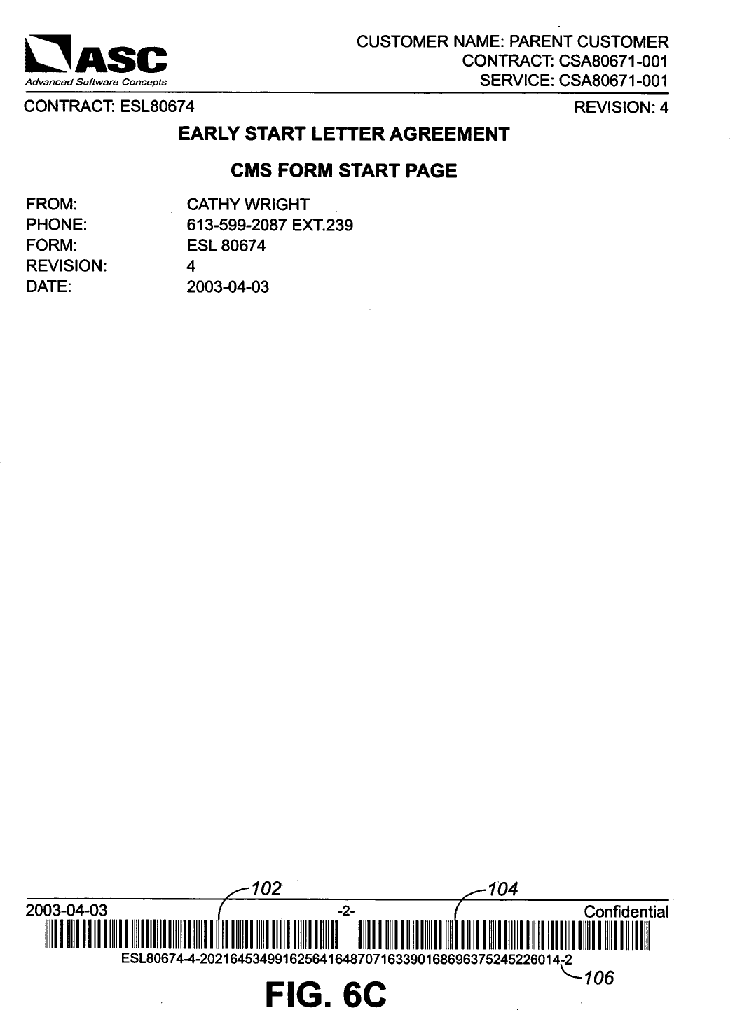

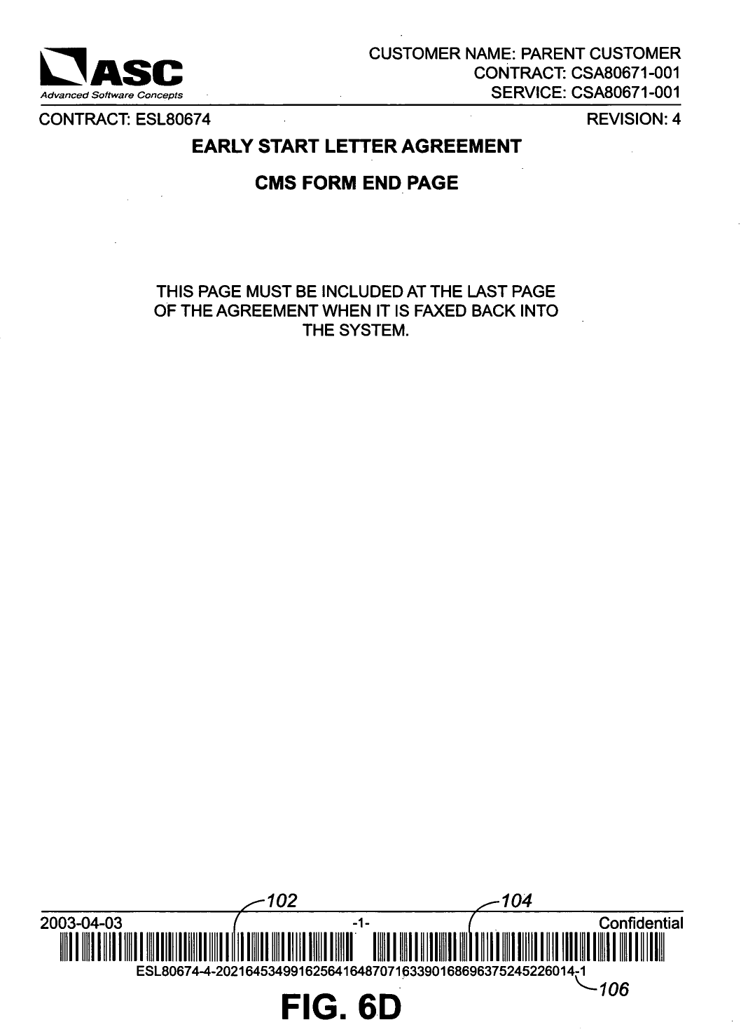

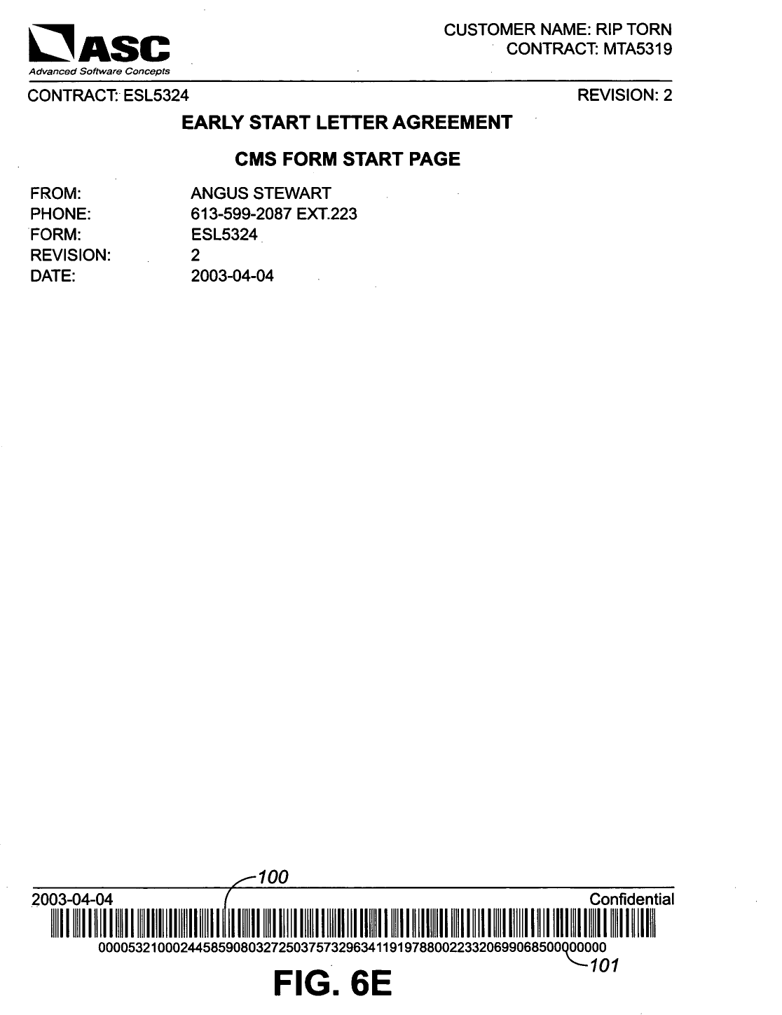

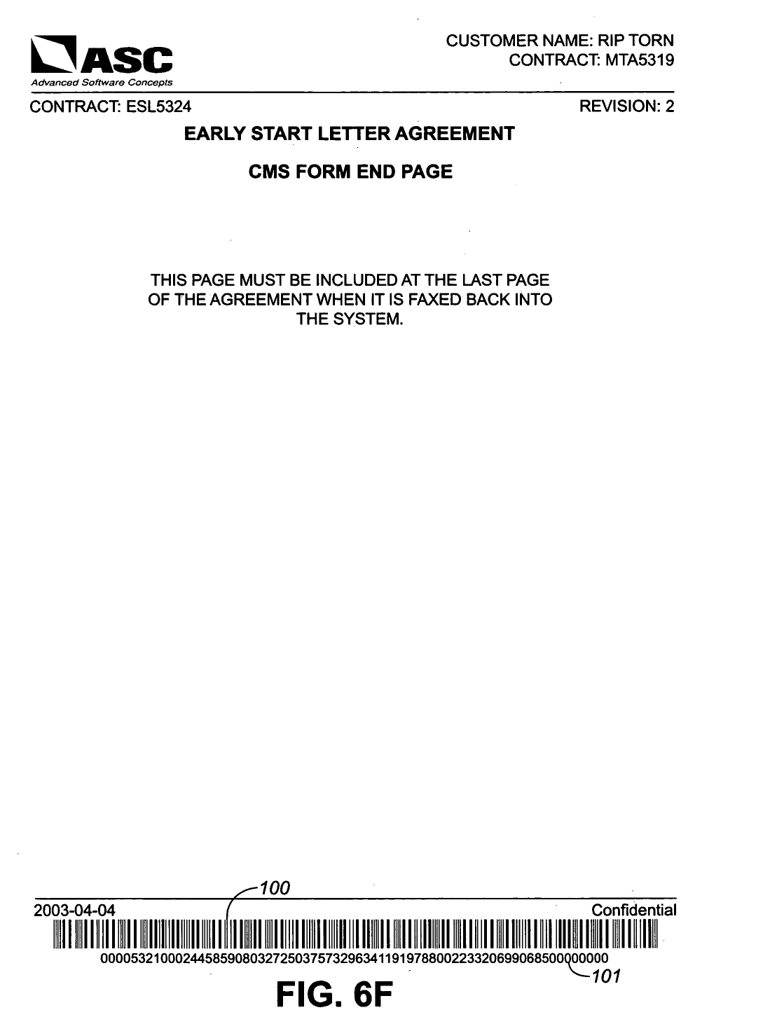

Referring to FIGS. 6 to 9, an alternate embodiment of the electronic document management system is disclosed. In this particular embodiment, the system is extended to accommodate the automatic input of externally generated content. More specifically, a system generated cover page is provided which is attached to externally generated content and which is used to track a document image inputted into the system. A cover page is necessary where additional schedules or diagrams are to be attached to a standardized agreement. Alternately, a cover page is required where a customized agreement is generated outside of the system in lieu of a user generated standardized agreement, such as the form-type electronic document template as described in relation to FIG. 2. Finally, a cover page would be used where a user wanted to enter historical documents (e.g. old contracts) into the electronic document management system.

The cover page contains a barcode that identifies it as a cover page and also, optionally, identifies the number of pages which make up the cover page and attached document. The system contemplates two scenarios:

(a) Known Page Count (FIGS. 6A and 6B)—The Receipt/Delivery server 55 will identify the cover page and accept the identified number of pages immediately following the cover page as “the content”. Referring to FIG. 6A, the matching barcodes 102, 104 used to identify the cover page contain document number, revision number, paging details and variable data relating to the externally generated content. When the Receipt/Delivery serve 55 encounters a known page count cover page, it will accept the cover page and the identified number of subsequent pages. The document number, revision number, paging details and variable data will be read from the cover page barcode. It should be understood that where the number of pages has been entered on the cover page, the trailing numbering reflected in the barcode of the first page will be zeroed, and the page count will be the user entered page count (see FIG. 6B, numeric string 101 which shows the 8 digit trailing string 00000002 meaning that there are two pages which will follow the cover page, since the user has entered “Pages to follow: 2”). Any barcodes encountered on the subsequent pages will compared to the barcode on the cover page. An unexpected barcode is an error condition which will cause the image to be rejected to a manual queue for processing;

(b) Unknown Page Count (FIGS. 6C to 6F)—if the number of pages is not entered, a cover page as shown in FIG. 6C and a trailing or end page as shown in FIG. 6C are used to frame the externally generated content. The Receipt/Delivery serve 55 would accept all pages, the cover page, end page and framed pages as a single document. It should be understood that for a cover page where no page number has been entered, the cover page will have the page number and page count zeroed (i.e. 00000000), while the barcode on the end page will have a page number and page count of 99999999 (see the 8 didgit trailing string in numeric string 101 of FIGS. 6E/6F). As with the known page count scenario, all pages in the set are scanned for barcodes and if one is found that does not agree with the cover barcode, an error is generated and the entire document is sent to a manual queue for processing.

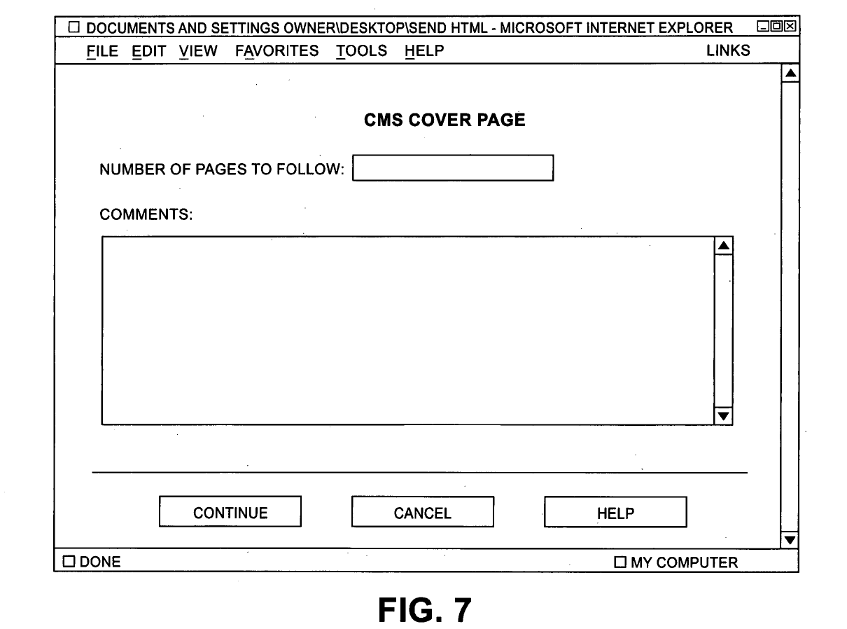

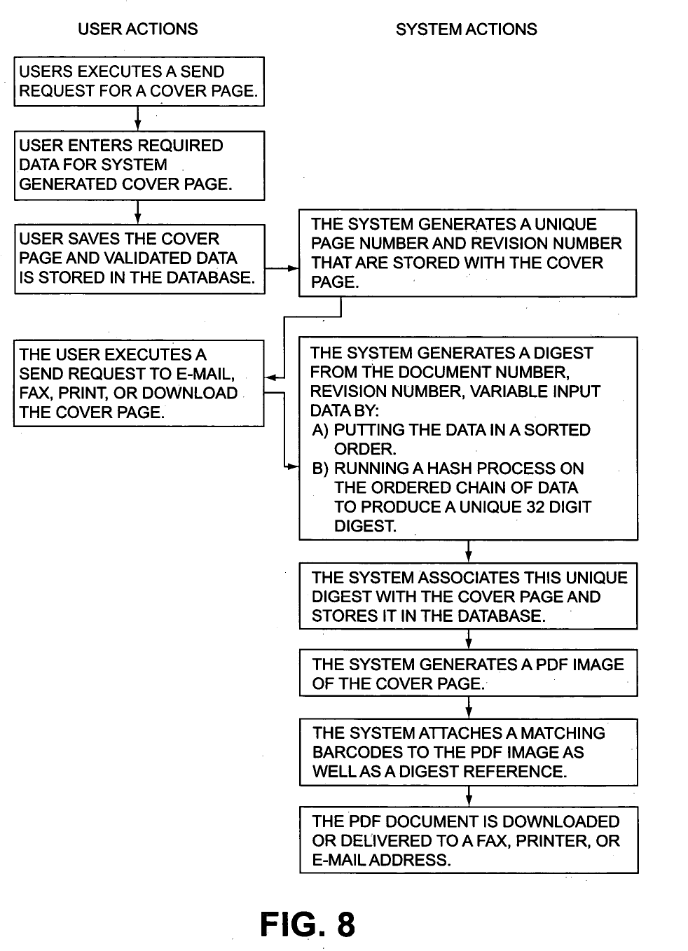

The preferred sequence of steps to create and store a barcode cover page will now be described in relation to FIG. 8. As shown in the flowchart, a user generates a cover page at a PC 30 using a software interface integral to the system and as shown in FIG. 7. The user first executes a send request for a cover page. As will be explained below, the user could also choose to send a package containing a cover page and an attached externally generated document (e.g. custom agreement). The interface then generates a cover page template which prompts the user to enter specified information. The user inputted data is validated and the document is stored in the Database 35 together with a system-generated unique document number and revision number for the cover page. The user then executes a send request to initiate a the process for forwarding the generated cover page to a recipient. A unique document digest (representing document number, revision number, and variable data stored in the system and associated with the externally generated content) is generated and the resulting digest is associated with the cover page and stored in Database 35. In the case of a custom agreement, the variable data might include, among other things, customer name, contract commencement date and contract length. A cover page image generator component of the system then generates a PDF image of the cover page. Matching barcodes 102, 104 comprising the document and revision numbers and paging details, are generated and attached to the cover page, while a digest reference comprising a unique alpha-numeric string 106 is also attached to the page. The PDF document is then delivered to the recipient (e.g. a printer 40, fax 50 or e-mail to PC 30. If the user has generated a custom agreement, this custom agreement can be attached to cover page and downloaded to a recipient's desktop. Alternately, the recipient may already have a custom agreement which it will associate with a received cover page and return to the system as will be discussed below.

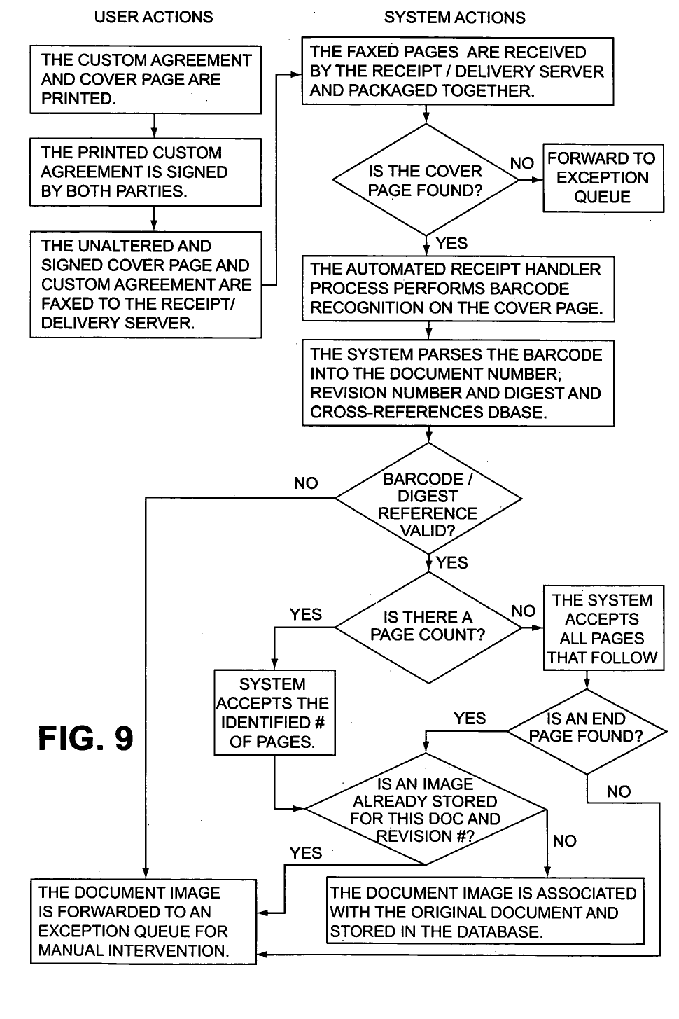

The preferred sequence of steps performed by the system to receive and store a hand-signed custom agreement with an attached barcoded cover page will now be described in relation to FIG. 9. The recipient first prints the cover page and attached custom agreement. The custom agreement is then executed. The cover page is attached to the signed agreement which is then faxed to the Receipt/Delivery server 55. The received image document is then checked for a cover page. If no cover page is found, the document image is sent to an exception queue for manual review. If a cover page is found, the Receipt/Delivery server 55 then scans the barcodes 102, 104 on the cover page. At this point, the system may optionally determine if barcodes 102, 104 match. If they do not they are sent to the exception queue. If they do match, the system then parses the barcode for document number, revision number and paging details. These barcode values and the digest reference 106 are then cross-referenced with the values and digest stored in Database server 35. As explained above, the digest is a representation of the document number, revision number and variable data associated with a custom agreement. The purpose of the digest is to validate the signed content with the system content. The assumption is that the cover page represents the state of the attached custom agreement at the time the cover page is generated. Therefore what is faxed by a user into the Receipt/Delivery server 55 can be visually verified with the content in the system, and that system content can be validated by regenerating the hash code and comparing it to the code on the faxed cover page. In other words, the digest is composed of all of the input components of the system document to which it belongs, including file attachments.

Continuing with the flowchart of FIG. 9, if the barcode or digest reference is not valid the document image is sent to the exception queue. If the barcode and digest reference are valid, the system determines if a page count is present on the cover page. If so, the system accepts the identified number of pages which follow. If not, the system accepts all of the pages that follows and looks for an end page. If no end page is found, the document is sent to the exception queue. After the document image is received, the system determines if a document image is already stored in the database. If there is already an image of a signed document, the document image is sent to the exception queue for manual intervention. If an image has yet to be stored, the document image is associated with the original document and stored in Database 35.

It should also be appreciated that the flowcharts of FIGS. 8 and 9 have been described in relation to the use of cover pages which includes matching barcodes 102, 104 and a digest reference 106 a cover page incorporating a single barcode 100 and numeric string 101 (as described in relation to FIG. 2) is also contemplated and meant to be included within the scope of the invention. FIGS. 6B, 6E and 6F provide examples of a cover page, start page and end page respectively where a single barcode 100 and numeric string 101 are used. It should also be appreciated that where a single barcode is used, the additional steps associated with matching barcodes 102, 104 and digest reference 106 in creating, storing, receiving and verifying the cover page would not have to be performed e.g. determining if barcodes 102, 104 match upon receipt of a cover page.

The user interface of the system which controls the send operation is adjusted to accommodate a cover page and customized agreement. The user interface allows selection between: (a) a standard electronic template form (see FIG. 2), reflected in one option called “Send PDF”; (b) a customized agreement or cover page, reflected in two options called “Send Customized Agreement” or “Send Cover Page”; and (c) a combined cover page and custom agreement reflected in one option called “Send Package”. The processing for the sending of either a PDF or a Customized Agreement is identical. However, when a user selects the “Send Cover Page” option, a request will be made to a software component to display a cover page template in which optional fields can be captured. The format of a cover page is PDF. As shown in FIGS. 6A and 6B, the cover page also includes information on the user who generated the cover (e.g. user name and phone number) as well as a comments section. The cover page would be sent by the user as a PDF. If the “Send Customized Agreement” is selected, the user would be able to download the agreement as a binary attachment.

It will be understood by those skilled in the art that a digital signature may be applied to the custom agreement by the recipient using third party validation services and then e-mailed with the cover page to the Receipt/Delivery server 55 where the recipient's security credentials would be authenticated by a digital signature authentication component using the Public Key Infrastructure (PKI). This would occur where the recipient received a soft copy of the cover page and custom agreement via e-mail to their PC 30 instead of a hard copy via fax 50 or similar device. Upon receipt by the Receipt/Delivery server 55, the authentication process as described in relation to FIGS. 5A and 5B would then be performed.

It will be appreciated by the reader that the foregoing electronic document management system and method provide effective means for closely and accurately tracking the contents of electronic documents exchanged between parties over a network and for verifying the validity of the contents of each page of an electronic document that has been hand-signed or digitally signed by one or more parties.

While the invention has been described herein with reference to a system and method for creating, managing and authenticating commercial contracts it will be apparent to the reader that the invention may be applied to any type of document which is subject to embodiment in an electronic format. Similarly, while it is preferable to interface the system to the user through a cellular telecommunications network and/or an Internet global communication network, to take advantage of the broad availability and accessibility of this network to users, the invention is not limited thereto and an intranet could instead be used. Further, it is to be understood that the specific system components described herein may be embodied in and implemented by any number of alternative discrete hardware components, as appropriate, and the embodiment described here is not intended to limit the scope of the invention which is defined solely by the appended claims. From the teachings provided herein, a person skilled in the art is able to implement the invention by means of alternative computer program embodiments.

The embodiments of the invention in which an exclusive property of privilege is claimed are defined as follows:

1. An electronic document management system for verifying externally generated content exchanged through a network, said externally generated content associated with a user generated cover page, said system comprising:
(a) a data capturing component for capturing data defining said cover page, wherein said data comprises at least user selected data, and forwarding said data for storage;
(b) a document digest generator for generating a digest from said defined cover page and said associated externally generated content by applying a secure algorithm thereto, whereby said digest is uniquely associated with said defined cover page and said associated externally generated content, and forwarding said digest for storage in association with said defined cover page and said associated externally generated content;
(c) a barcode generator for generating a barcode from said generated digest wherein said barcode uniquely identifies said defined covered page and said associated externally generated content;
(d) a document forwarding component for forwarding said defined cover page with said barcode added thereto and said associated externally generated content to a recipient;
(e) a document receiving component for receiving from said recipient said associated externally generated content preceded by said defined cover page; and,
(f) a barcode verification component for determining the validity of said barcode of said received cover page wherein a digest component of said barcode is compared to said stored digest associated with said defined cover page and said associated externally generated content.

2. An electronic document management system according to claim 1, wherein said associated externally generated content is a custom agreement and wherein said received associated externally generated content is a signed custom agreement.

3. An electronic document management system according to claim 2 wherein a unique document number is generated for said defined cover page and associated custom agreement, said document number is stored with said captured data and said digest is generated from said defined cover page, said associated custom agreement and said document number.

4. An electronic document management system according to claim 3 wherein a unique document revision number is generated for said defined cover page and associated custom agreement, said document revision number is stored with said captured data and said digest is generated from said defined cover page, said associated custom agreement, and said document and revision numbers.

5. An electronic document management system according to claim 4 wherein a unique barcode for said defined cover page is generated by said barcode generator from said digest, and said document and revision numbers, and wherein said unique barcode is added to said defined cover page, and wherein the resulting barcoded defined cover page and said associated custom agreement are forwarded by said document forwarding component.

6. An electronic document management system according to claim 5 wherein said unique barcode optionally contains a page numbering indicator reflecting the page count of said associated custom agreement.

7. An electronic document management system according to claim 6 further including a cover page checking component to determine if said cover page has been received,
wherein if said cover page has been received and if said unique barcode also includes said page numbering indicator, receiving and associating the identified number of pages with said cover page;
and wherein if said cover page is received and said unique barcode does not include said page numbering indicator, receiving and accepting all pages that follow said cover page until an end page is encountered.

8. An electronic document management system according to claim 7 further comprising a document image generator for generating an electronic image of said barcoded defined cover page, wherein said document forwarding component forwards said electronic image.

9. An electronic document management system according to claim 8 wherein said electronic image of said barcoded defined cover page is a portable document format (PDF) document.

10. An electronic document management system according to claim 8 wherein said received custom agreement has been hand-signed and said signed custom agreement preceded by said defined cover page is faxed by said recipient to said document receiving component.

11. An electronic document management system according to claim 8 further comprising a digital exchange key generator for generating a unique digital exchange key associated with said defined cover page, said generated unique digital exchange key being generated by applying said secure algorithm to said electronic image, and forwarding said digital exchange key for storage.

12. An electronic document management system according to claim 11 wherein said custom agreement received by said document receiving component comprises a digital signature and said system further comprises a digital signature authentication component for authenticating said digital signature and a digital exchange key verification component for determining the validity of said received custom agreement, wherein said digital exchange key verification component determines a digital exchange key by applying said secure algorithm to said received custom agreement and comparing said determined digital exchange key to said stored unique digital exchange key associated with said defined cover page.

13. A method for managing and verifying externally generated content exchanged through a network, said externally generated content associated with a user generated cover page, said method comprising:
(a) capturing data defining said cover page, whereby said data comprises at least user selected data, and forwarding said data for storage;
(b) generating a digest from said defined cover page and associated externally generated content by applying a secure algorithm thereto whereby said digest is uniquely associated with said defined cover page and said associated externally generated content, and forwarding said digest for storage in association with said defined cover page and said associated externally generated content;
(c) generating a barcode from said generated digest wherein said barcode uniquely identifies said defined cover page and said associated externally generated content;
(d) forwarding said defined cover page with said barcode added thereto and said associated externally generated content to a recipient;
(e) receiving from said recipient said associated externally generated content preceded by said defined cover page; and,
(f) determining the validity of said barcode of said received cover page wherein a digest component of said barcode is compared to said stored digest associated with said defined cover page and said associated externally generated content.

14. A method according to claim 13 wherein said externally generated content is a custom agreement and wherein said received externally generated content is a signed custom agreement.

15. A method according to claim 14 wherein said user inputs said user selected data into a pre-determined electronic cover page template and said data defining said cover page comprises said user selected data and said pre-determined electronic cover page template.

16. A method according to claim 15 further comprising generating a unique document number for said defined cover page and said associated custom agreement and forwarding said document number for storage with said captured data, whereby said digest is generated from said defined cover page, said associated custom agreement and said document number.

17. A method according to claim 16 further comprising generating a unique document revision number for said defined cover page and said associated custom agreement and forwarding said document revision number for storage with said captured data, whereby said digest is generated from said defined cover page, said associated custom agreement, and said document and revision numbers.

18. A method according to claim 17 further comprising: generating a unique barcode for said defined cover page from said digest, and said document and revision numbers; adding said unique barcode to said cover page; and forwarding the resulting barcoded defined cover page and associated custom agreement to a recipient.

19. A method according to claim 18 further comprising optionally including in said unique barcode a page numbering indicator reflecting the page count of said associated custom agreement.

20. A method according to claim 19 further comprising determining if said defined cover page has been received,
wherein if said cover page has been received and if said unique barcode also includes said page numbering indicator, receiving and associating the identified number of pages with said cover page;
and wherein if said cover page has been received and said unique barcode does not include said page numbering indicator, receiving and accepting all pages that follow said cover page until an end page is encountered.

21. A method according to claim 18 further comprising generating an electronic image of said barcoded defined cover page and forwarding said electronic image for use by said recipient.

22. A method according to claim 21 wherein said electronic image of said barcoded defined cover page is a portable document format (PDF) document.

23. A method according to claim 21 further comprising generating a unique digital exchange key associated with said defined cover page by applying said secure algorithm to said electronic image and forwarding said digital exchange key for storage.

24. A method according to claim 23 whereby said custom agreement received by a document receiving component comprises a digital signature, said method further comprising:
(a) authenticating said digital signature; and,
(b) determining the validity of said received custom agreement by applying said secure algorithm to said received custom agreement and comparing the resulting determined digital exchange key to said stored unique digital exchange key associated with said defined cover page.

25. A method according to claim 21 wherein said received custom agreement has been hand-signed and said signed custom agreement preceded by said defined cover page is faxed by said recipient to said document receiving component.

26. An electronic document management system for verifying the contents of an electronic document exchanged through a network and comprising variable data input by a user, said system comprising:
(a) a data capturing component for capturing data defining an electronic document, wherein said data comprises at least said variable data, and forwarding said data for storage;
(b) a document digest generator for generating a digest from said defined electronic document by applying a secure algorithm thereto, wherein said digest is uniquely associated with said defined electronic document, and forwarding said digest for storage in association with said defined electronic document;
(c) an identifier generator for generating at least two matching indicators and a digest reference wherein said at least two matching indicators and said digest reference uniquely identify said defined electronic document and the contents thereof;
(d) a document forwarding component for forwarding said defined electronic document with said at least two matching indicators and said digest reference added thereto for use by a user;
(e) a document receiving component for receiving from a user a signed electronic document comprising variable data, at least two matching indicators and a digest reference; and,
(f) an indicator and digest verification component for determining the validity of said at least two indicators and said digest reference associated with said received electronic document.

27. An electronic document management system according to claim 26 wherein said at least two indicators are barcodes, and wherein said digest reference is an alpha-numeric string.

28. An electronic document management system according to claim 27, wherein said at least two barcodes identify a document number, revision number and page number associated with said defined electronic document.

29. An electronic document management system according to claim 28 wherein said determining in step (f) comprises scanning said at least two barcodes, and wherein if a specified number of said at least two barcodes match, said signed electronic document is accepted.

30. An electronic document management system according to claim 29 wherein said digest reference associated with said signed electronic document is compared to said stored digest associated with said defined electronic document and if said stored digest and digest reference matches, said signed electronic document is accepted.

31. An electronic document management system according to claim 28 wherein said determining in step (f) comprises scanning said at least two barcodes, and wherein if at least one of said at least two barcodes is legible, accepting said signed electronic document.

32. An electronic document management system according to claim 26 wherein said at least one indicator is a three-dimensional image representing a document number, a revision number and a page numbering relating to said electronic document.

33. An electronic document management system according to claim 27, wherein said defined electronic document is a template contract and said identifier generator calculates the space available on a specified page of said template contract and adjusts the size and placement of said at least matching barcodes and said alpha-numeric string accordingly.

34. An electronic document management system for verifying externally generated content exchanged through a network, said externally generated content associated with a user generated cover page, said system comprising:
(a) a data capturing component for capturing data defining said cover page, wherein said data comprises at least user selected data, and forwarding said data for storage;
(b) a document digest generator for generating a digest from said defined cover page and said associated externally generated content by applying a secure algorithm thereto, whereby said digest is uniquely associated with said defined cover page and said associated externally generated content, and forwarding said digest for storage in association with said defined cover page and said associated externally generated content;
(c) a barcode generator for generating at least two matching barcodes and a digest reference wherein said at least two matching barcodes and said digest reference uniquely identify said defined covered page and said associated externally generated content;
(d) a document forwarding component for forwarding said defined cover page with said at least two matching barcodes and said digest reference added thereto, and said associated externally generated content to a recipient;
(e) a document receiving component for receiving from said recipient said associated externally generated content preceded by said defined cover page; and,
(f) an barcode and digest verification component for determining the validity of said at least two barcodes and said digest reference associated with said received cover page.

35. An electronic document management system for verifying the contents of an electronic document exchanged through a network and comprising variable data input by a user, said system comprising:
(a) a data capturing component for capturing data defining an electronic document, wherein said data comprises at least said variable data, and forwarding said data for storage;
(b) a document digest generator for generating a digest from said defined electronic document by applying a secure algorithm thereto, whereby said digest is uniquely associated with said defined electronic document, and forwarding said digest for storage in association with said defined electronic document;
(c) a barcode generator for generating a barcode from said generated digest whereby said barcode uniquely identifies said defined electronic document and the contents thereof;
(d) a document forwarding component for forwarding said defined electronic document with said barcode added thereto for use by a user;
(e) a document receiving component for receiving from a user a signed electronic document comprising variable data and a barcode; and,
(f) a barcode verification component for determining the validity of said barcode of said received electronic document wherein a digest component of said barcode is compared to said stored digest associated with said defined electronic document
wherein said defined electronic document is a template contract said barcode generator calculates the space available on a specified page of said template contract adjusts the size and placement of said barcode accordingly.
